(19) United States
(12) Patent Application Publication
(10) Pub. No.: US 2013/0022108 A1
(43) Pub. Date: Jan. 24, 2013

(54) QUANTIZATION PARAMETER DERIVATION FROM QP PREDICTOR

(71) Applicants: Krit Panusopone, San Diego, CA (US); Ajay K. Luthra, San Diego, CA (US); Limin Wang, San Diego, CA (US); Xue Fang, San Diego, CA (US); Jae Hoon Kim, Santa Clara, CA (US)

(72) Inventors: Krit Panusopone, San Diego, CA (US); Ajay K. Luthra, San Diego, CA (US); Limin Wang, San Diego, CA (US); Xue Fang, San Diego, CA (US); Jae Hoon Kim, Santa Clara, CA (US)

(73) Assignee: GENERAL INSTRUMENT CORPORATION, Horsham, PA (US)

(21) Appl. No.: 13/540,157

(22) Filed: Jul. 2, 2012

Related U.S. Application Data
(60) Provisional application No. 61/503,597, filed on Jun. 30, 2011.
(60) Provisional application No. 61/503,566, filed on Jun. 30, 2011.
(60) Provisional application No. 61/506,550, filed on Jul. 11, 2011.
(60) Provisional application No. 61/511,013, filed on Jul. 22, 2011.
(60) Provisional application No. 61/538,293, filed on Sep. 23, 2011.
(60) Provisional application No. 61/538,792, filed on Sep. 23, 2011.
(60) Provisional application No. 61/547,760, filed on Oct. 17, 2011.
(60) Provisional application No. 61/547,033, filed on Oct. 13, 2011.
(60) Provisional application No. 61/557,419, filed on Nov. 9, 2011.
(60) Provisional application No. 61/558,417, filed on Nov. 10, 2011.
(60) Provisional application No. 61/559,040, filed on Nov. 11, 2011.
(60) Provisional application No. 61/586,780, filed on Jan. 14, 2012.
(60) Provisional application No. 61/590,803, filed on Jan. 25, 2012.

(51) Int. Cl. H04N 7/32

(52) U.S. Cl. 375/240.03; 375/E07.245

(57) ABSTRACT

A method for determining quantization parameters is provided. The method includes determining one or more first units of video content in a grouping of units and analyzing whether the one or more first units of video content within a region in the grouping of units have coefficients for the video content that are zero. The method then determines whether a quantization parameter for one or more second units of video content different from the one or more first units of video content is to be used to derive the quantization parameter for the one or more first units of video content. When the quantization parameter for the one or more second units of video content is to be used, the quantization parameter for the one or more first units of video content is derived from the quantization parameter for the one or more second units of video content.

### CROSS REFERENCE TO RELATED APPLICATIONS

The present application claims priority to:

U.S. Provisional App. No. 61/503,597 for “Method for Quantization Quadtree for HEVC” filed Jun. 30, 2011;

U.S. Provisional App. No. 61/503,566 for “Method for Adaptive QP Coding at Sub-CU Level” filed Jun. 30, 2011;

U.S. Provisional App. No. 61/506,550 for “Predictive QP Coding at Sub-CU Level” filed Jul. 11, 2011;

U.S. Provisional App. No. 61/511,013 for “Coding Delta QP at TU Block” filed Jul. 22, 2011;

U.S. Provisional App. No. 61/538,293 for “QP Coding Methods for Sub-CU Level Adaptation” filed Sep. 23, 2011;

U.S. Provisional App. No. 61/538,792 for “QP Coding in CU and TU” filed Sep. 23, 2011;

U.S. Provisional App. No. 61/547,760 for “CU and TU Combined QP Coding with Maximum Depth Threshold Control” filed Oct. 5, 2011;

U.S. Provisional App. No. 61/547,033 for “CU dQP syntax Change and Combing with TU dQP syntax” filed Oct. 13, 2011;

U.S. Provisional App. No. 61/557,419 for “A proposal for the coding of TU Delta QP at the same TU Depth” filed Nov. 9, 2011;

U.S. Provisional App. No. 61/558,417 for “QP Adaptation at Sub-CU level” filed Nov. 10, 2011; and

U.S. Provisional App. No. 61/559,040 for “A Unified CU and TU QP Coding with Separable Depth Threshold Control” filed Nov. 11, 2011;

U.S. Provisional App. No. 61/586,780 for “QP Adaptation at Sub-CU level in HEVC” filed Jan. 14, 2012; and

U.S. Provisional App. No. 61/590,803 for “Syntax of QP Adaptation at Sub-CU level in HEVC” filed Jan. 25, 2012, the contents of all of which are incorporated herein by reference in their entirety.

### BACKGROUND

Video compression systems employ block processing for most of the compression operations. A block is a group of neighboring pixels and may be treated as one coding unit in terms of the compression operations. Theoretically, a larger coding unit is preferred to take advantage of correlation among immediate neighboring pixels. Various video compression standards, e.g., Motion Picture Expert Group (MPEG)-1, MPEG-2, and MPEG-4, use block sizes of 4×4, 8×8, and 16×16 (referred to as a macroblock (MB)).

High efficiency video coding (HEVC) is also a block-based hybrid spatial and temporal predictive coding scheme. HEVC partitions an input picture into square blocks referred to as largest coding units (LCUs) as shown in FIG. 1A. Unlike prior coding standards, the LCU can be as large as 128×128 pixels. Each LCU can be partitioned into smaller square blocks called coding units (CUs). FIG. 1B shows an example of an LCU partition of CUs. An LCU 100 is first partitioned into four CUs 102. Each CU 102 may also be further split into four smaller CUs 102 that are a quarter of the size of the CU 102. This partitioning process can be repeated based on certain criteria, such as limits to the number of times a CU can be partitioned may be imposed. As shown, CUs 102-1, 102-3, and 102-4 are a quarter of the size of LCU 100. Further, a CU 102-2 has been split into four CUs 102-5, 102-6, 102-7, and 102-8.

A quadtree data representation is used to describe how an LCU 100 is partitioned into CUs. FIG. 1C shows a quadtree 104 of the LCU partition shown in FIG. 1B. Each node of quadtree 104 is assigned a flag of “1” if the node is further split into four sub-nodes and assigned a flag of “0” if the node is not split. The flag is called a split bit (e.g. 1) or stop bit (e.g., 0) and is coded in a compressed bitstream.

A node 106-1 includes a flag “1” at a top CU level because LCU 100 is split into 4 CUs. At an intermediate CU level, the flags indicate whether a CU 102 is further split into four CUs 102. In this case, a node 106-3 includes a flag of “1” because CU 102-2 has been split into four CUs 102-5-102-8. Nodes 106-2, 106-4, and 106-5 include a flag of “0” because these CUs 102 are not split. Nodes 106-6, 106-7, 106-8, and 106-9 are at a bottom CU level and hence, no flag bit of “0” or ‘1” is necessary for those nodes because corresponding CUs 102-5-102-8 are not split. The quadtree data representation for quadtree 104 shown in FIG. 1C may be represented by the binary data of “10100”, where each bit represents a node 106 of quadtree 104. The binary data indicates the LCU partitioning to the encoder and decoder, and this binary data needs to be coded and transmitted as overhead.

In some cases, each CU may be associated with a quantization parameter. The quantization parameter regulates how much spatial detail is saved. When the quantization parameter is very small, almost all of the detail is retained. As the quantization parameter is increased, some of that detail is aggregated so that the bitrate drops resulting in some increase in distortion and some loss of quality. The quantization parameter needs to be signaled from an encoder to a decoder. In one example, every quantization parameter for every CU is signaled. This constitutes a lot of overhead.

The differences in quantization parameters may also be sent. The encoder only sends the difference between a quantization parameter of a previously-coded CU and a quantization parameter for a current CU. Although the differences reduce the amount of overhead, the differences still need to be sent for every CU.

### SUMMARY

In one embodiment, a method for determining quantization parameters is provided. The method includes determining one or more first units of video content in a grouping of units and analyzing whether the one or more first units of video content in the grouping of units have all the coefficients for the video content that are zero. The method then determines whether a quantization parameter for one or more second units of video content different from the one or more first units of video content is to be used to derive the quantization parameter for the one or more first units of video content. When the quantization parameter for the one or more second units of video content is to be used, the quantization parameter for the one or more first units of video content is derived from the quantization parameter for the one or more second units of video content.

In one embodiment, a method is provided for determining quantization parameters for one or more first units of video content in a grouping of units, the method comprising: determining, by a computing device, a quantization parameter for one or more second units of video content different from the one or more first units of video content; determining, by the computing device, the received quantization parameter is to be used to derive a quantization parameter for the one or more first units of video content, wherein the one or more first units of video content are in the grouping of units and have all the coefficients for the video content that are zero; and using, by the computing device, the derived quantization parameter in decoding the one or more first units of video content.

In one embodiment, a method for encoding video content is provided. The method includes receiving a unit of video content where the unit is partitioned into a grouping of blocks. Quantization parameters associated with the grouping of blocks are determined The method then determines a quantization parameter representation based on the quantization parameters and the grouping of blocks. When a node of the quantization parameter representation is associated with a block that is split into additional blocks, node information is set to indicate whether or not the additional blocks have a same quantization parameter. The method sends quantization information for the quantization parameters for the grouping of blocks based on the quantization parameter representation.

In one embodiment, a method for decoding video content includes: receiving a bitstream for a unit of video content, wherein the unit is partitioned into a grouping of blocks; determining, by a computing device, a quantization parameter representation based on a plurality of quantization parameters and the grouping of blocks, wherein when a node of the quantization parameter representation is associated with a block that is split into additional blocks, node information is set to indicate whether or not the additional blocks have a same quantization parameter; determining, by the computing device, a quantization parameter associated with a current block being decoded using the quantization parameter representation; and using the quantization parameter in a quantization step.

The following detailed description and accompanying drawings provide a more detailed understanding of the nature and advantages of particular embodiments.

### BRIEF DESCRIPTION OF THE DRAWINGS

FIG. 1A shows an example of a largest coding unit (LCU).

FIG. 1B shows an example of an LCU partition of coding units (CUs).

FIG. 1C shows a quadtree of the LCU partition shown in FIG. 1B.

FIG. 2 shows an example of a system for encoding and decoding video content according to one embodiment.

FIG. 3 shows an example of a CU partition of the LCU according to one embodiment.

FIG. 4 shows a quantization unit partition for the LCU according to one embodiment.

FIG. 5A shows an example of a coding unit quadtree (CQT) according to one embodiment.

FIG. 5B shows an example of a quantization unit quadtree (QQT) according to one embodiment.

FIG. 6 shows a first scenario for the QQT according to one embodiment.

FIG. 7 shows a second scenario for the QQT according to one embodiment.

FIG. 8 shows an example of a third scenario for the QQT according to one embodiment.

FIG. 9 depicts a fourth scenario for the QQT according to one embodiment.

FIG. 10 shows a fifth example of the QQT according to one embodiment.

FIG. 11 shows the scan order within an LCU according to one embodiment.

FIG. 12 shows the five possible coded neighbor CUs for a current CU according to one embodiment.

FIG. 13 depicts an example of a TU partitioning within an LCU.

FIG. 14 depicts the following QP values are used according to one embodiment.

FIG. 15 depicts the QP values that are used according to one embodiment.

FIG. 16 depicts an example of a unit of video content being coded using QP adaptation according to one embodiment.

FIG. 17 depicts a simplified flowchart for using a QQT at the encoder according to one embodiment.

FIG. 18 depicts a simplified flowchart for using a QQT at the decoder according to one embodiment.

FIG. 19A depicts an example of the encoder according to one embodiment.

FIG. 19B depicts an example of the decoder according to one embodiment.

### DETAILED DESCRIPTION

Described herein are techniques for a video compression system. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

### Quantization Unit Quadtree

FIG. 2 shows an example of a system for encoding and decoding video content according to one embodiment. The system includes an encoder 200 and a decoder 201, both of which will be described in more detail below.

A quantization parameter (QP) is allowed to vary from block to block, such as from coding unit (CU) to CU. Particular embodiments use a quantization unit (QU) to represent an area with the same quantization parameter. For example, a quantization unit may cover multiple CUs. As will be discussed, below, overhead in signaling between encoder 200 and decoder 201 may be saved by not sending information for quantization parameters for some blocks within a quantization unit.

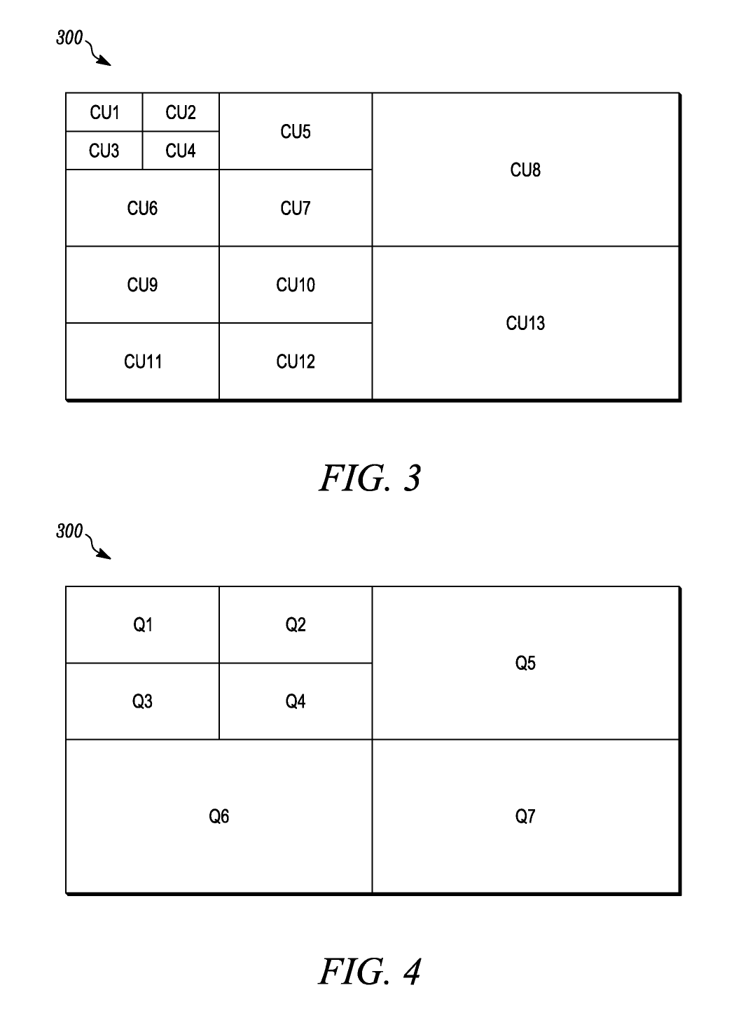

FIG. 3 shows an example of a CU partition of an LCU 300 according to one embodiment and FIG. 4 shows a quantization unit partition for LCU 300 according to one embodiment. Some CUs may share the same quantization parameter. These CUs may be grouped into a quantization unit. For example, coding units CU1, CU2, CU3, and CU4 share the same quantization parameter Q1. In this case, the area covered by coding units CU1, CU2, CU3, and CU4 is considered one quantization unit. Also, the area covered by coding units CU9, CU10, CUM and CU12 shares the same quantization parameter Q6 and is therefore also considered one quantization unit. Coding units CU8 and CU13 do not share the same quantization parameter and are not associated with a quantization unit. In this case, coding unit CU8 is associated with quantization parameter Q5 and coding unit CU13 is associated with quantization parameter Q7.

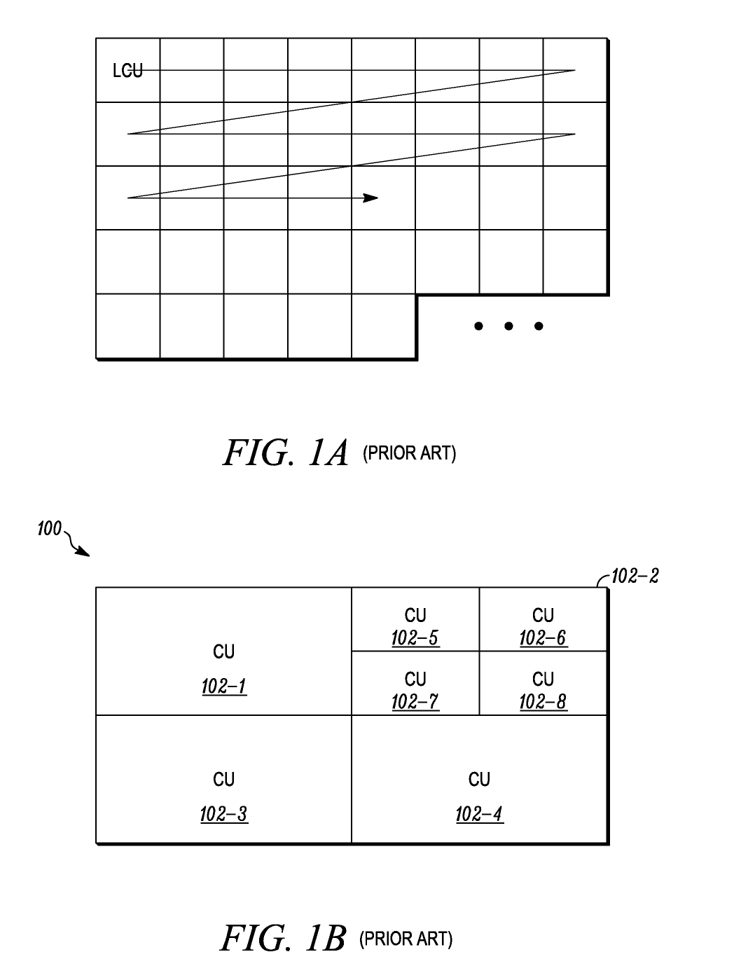

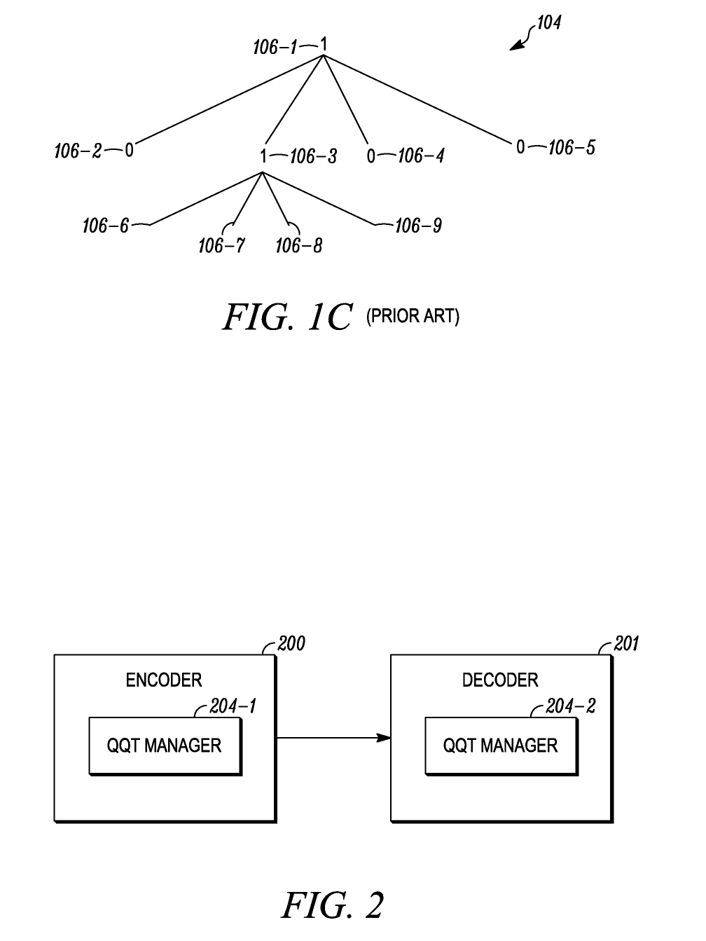

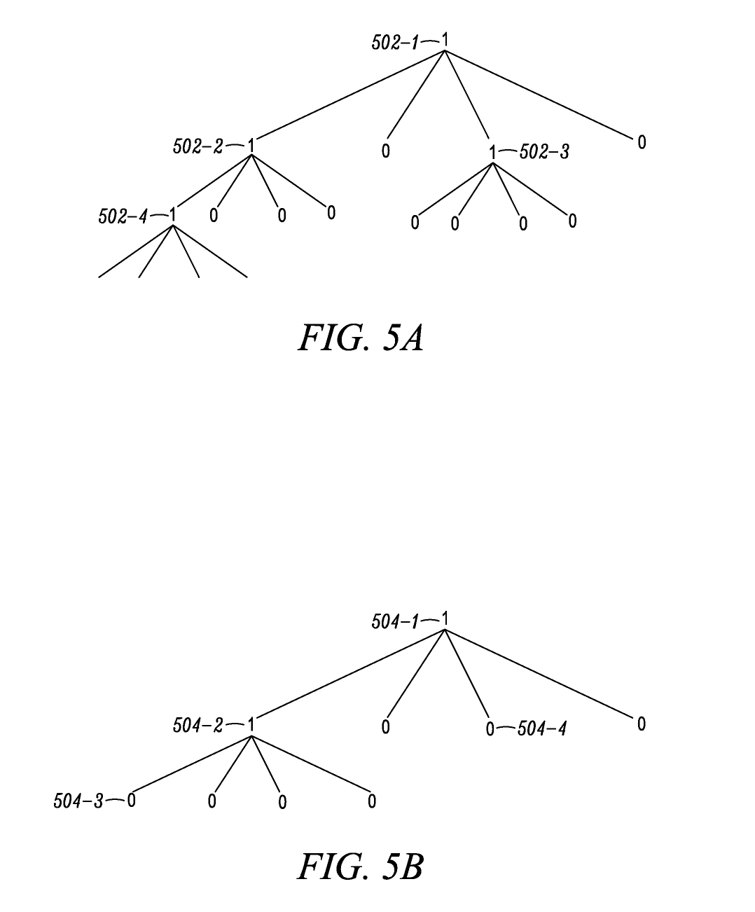

The coding unit partition may be associated with a data structure that describes the partitioning. For example, a coding unit quadtree (CQT) can be generated based on the partitioning of CUs in the LCU. FIG. 5A shows an example of a CQT according to one embodiment. The CQT may be determined as described above with respect to FIG. 1C.

In addition to the CQT, particular embodiments use another data structure, such as a quadtree representation, to describe the partitioning of the quantization units. For example, a quantization unit quadtree (QQT) is used to represent the partitioning of quantization units. The QQT follows the coding unit quadtree. For example, as in the CQT, the QQT starts at the LCU level. If the CQT assigns a bit “1” at a node, then this means there are other blocks, such as four blocks, branched out from this node. Then, the QQT also needs to assign a bit, either “0” or “1”, at the node, indicating if the four blocks share the same quantization parameter or not. Otherwise, if the CQT assigns a bit “0” at a node meaning there are no blocks branched out from this node, the QQT does not need to insert any bit at the node as there are no blocks branching out from the node. Although bit values of “1” and “0” are described, it will be understood that other information may be assigned to the quadtrees.

Referring to FIG. 5A, a node 502-1 indicates the LCU is split into four CUs. Also, nodes 502-2 and 502-3 indicate a corresponding CU is split into four CUs. For example, nodes 502-2 and 502-4 correspond to coding units CU1-CU7. A node 502-4 indicates that another unit is split into four coding units. For example, node 502-4 corresponds to coding units CU1-CU4. Also, node 502-3 corresponds to coding units CU9-CU12.

Referring to FIG. 5B, for each node in the CQT in which nodes are split, a bit is set to indicate whether the quantization parameter for the blocks branched out from that node are the same. For example, a bit is set at “0” if the quantization parameters for blocks branching out for that node are the same and set at “1” if the quantization parameters for the blocks are different. In one example, node 504-1 indicates that the quantization parameters are different for the four blocks branching out from node 504-1. Node 504-2 is set at “1”, which indicates that the quantization parameters are also different. A node 504-3 is set at “0”, which indicates that coding units CU1-CU4 have the same quantization parameter Q1. Also, a node 504-4 is set at “0” and this indicates that these coding units CU9-CU12 share the same quantization parameter Q6.

Referring back to FIG. 2, a QQT manager 204-1 in encoder 200 generates a QQT based on the quantization parameters for the coding units. QQT manager 204 then sends information for the QQT to decoder 201. Because the QQT is sent, information for quantization parameters for some coding units might not have to be sent. For example, if a set of coding units have the same quantization parameter, then encoder 200 sends information for the quantization parameter for one coding unit in the quantization unit. Then, encoder 200 does not need to send the same information for the quantization parameter for the other coding units because the quantization parameter is the same. Rather, the QQT is used to determine that the same quantization parameter is applied to the set of coding units. In one embodiment, encoder 200 determines the QP differences, which are coded and transmitted instead of the quantization parameter. Using the QQT, certain differences may not have to be sent.

A QQT manager 204-2 in decoder 201 receives the QQT and then interprets the QQT to determine quantization parameters for the coding units. For example, the quantization parameter is determined for a CU in a set of CUs. If the QQT indicates the set of CUs include the same quantization parameter, decoder 201 uses that quantization parameter in a quantization step for all the CUs.

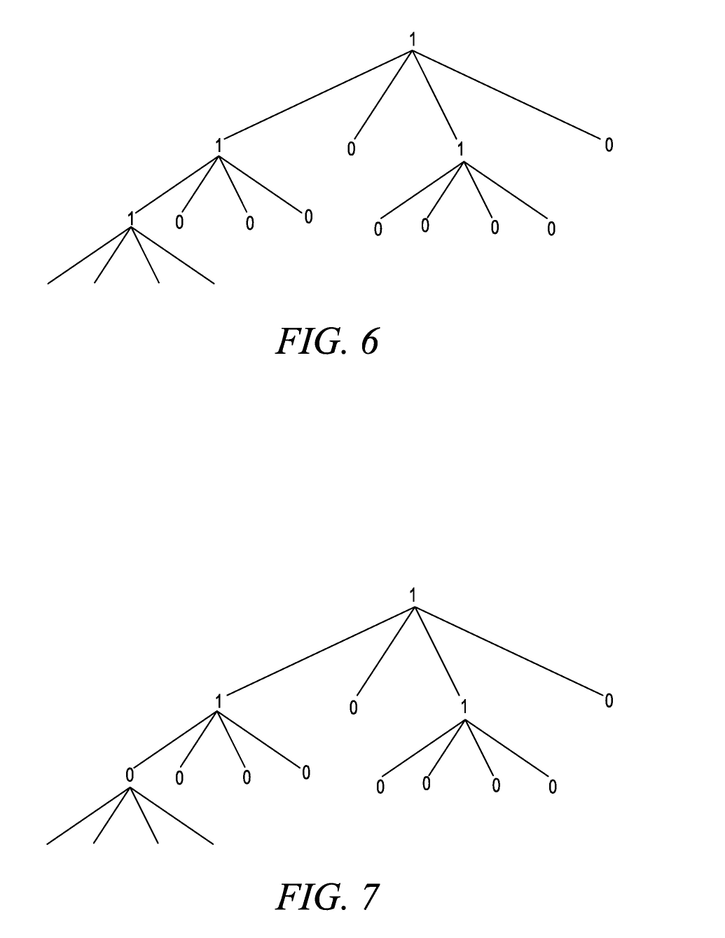

The QQT is overhead in that the QQT needs to be signaled from encoder 200 to decoder 201. However, as discussed above, overhead may be saved because information for quantization parameters for each coding unit may not need to be sent. The following examples illustrate the possible scenarios in which the QQT may be coded depending on the QU partition within the LCU. Conventionally, the differences, dQ1, dQ2, dQ3, dQ4, dQ5, dQ6, dQ7, dQ8, dQ9, dQ10, dQ11, dQ12, and dQ13, are sent for all the CUs 1-13, respectively. FIG. 6 shows a first scenario for the QQT according to one embodiment. In the first scenario, none of the four blocks branched out from nodes in the CQT share the same quantization parameter values. In this case, the differences for all of the CUs, CU1-CU13, need to be coded and transmitted. Additionally, the overhead for the QQT is 4 bits of “1111”.

FIG. 7 shows a second scenario for the QQT according to one embodiment. If four blocks branched out from any node of the CQT share the same quantization parameter value, overhead may be saved. For example, if CU1, CU2, CU3, and CU4 share the same quantization parameter, the bits for 3 QP differences, the differences dQ2, dQ3, and dQ4 can be saved (i.e., these differences do not need to be sent). The overhead for the QQT is 4 bits of “1110”.

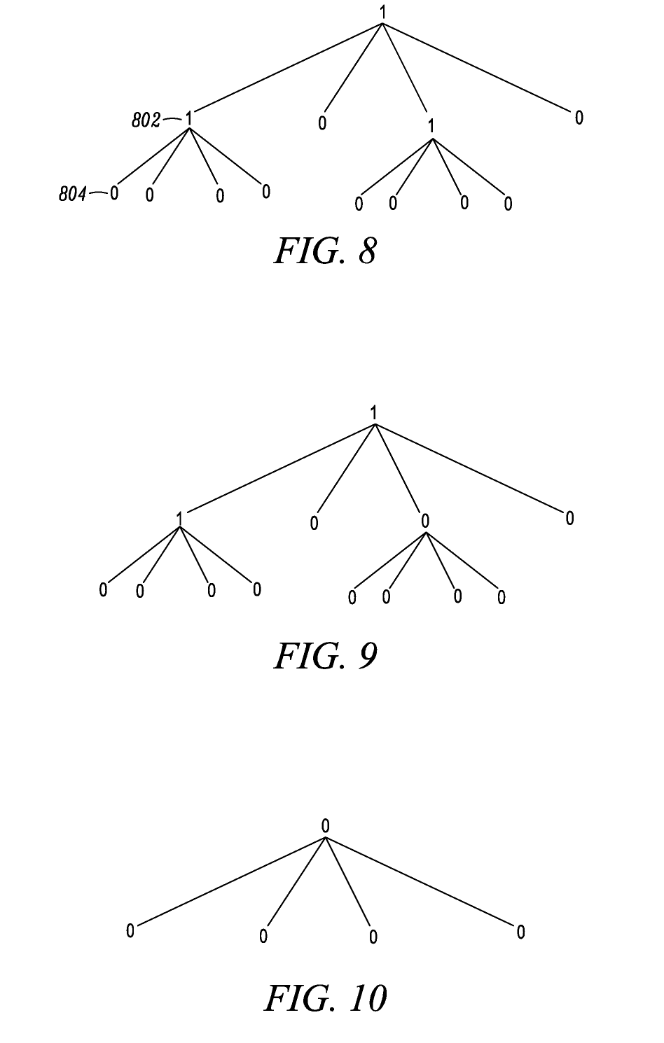

FIG. 8 shows an example of a third scenario for the QQT according to one embodiment. If coding units CU1-CU7 share the same quantization parameter, the bits for 6 quantization parameter differences, dQ2-dQ7, can be saved. The QQT overhead is 3 bits of “101”. Bits for blocks under a node 802 do not need to be sent because the “0” value indicates that the quantization parameters are the same for blocks branching out from node 802. Even though a coding unit associated with a node 804 branches out to four more blocks, the “0” value at node 802 indicates that these four more blocks have the same quantization parameters and thus a bit of “0” does not need to be sent for node 804.

FIG. 9 depicts a fourth scenario for the QQT according to one embodiment. If CU1-CU7 share the same quantization parameter, and CU9-CU12 share another quantization parameter, the bits for 9 QP differences, dQ2-dQ7 and dQ10-dQ12, can be saved. The QQT overhead is 3 bits of “100”.

FIG. 10 shows a fifth example of the QQT according to one embodiment. If the quantization parameter is the same for all CUs, then only one difference, dQ1, needs to be coded and transmitted. The bits for 12 QP differences, dQ2-dQ13, are saved. The QQT overhead is now 1 bit of “0”.

Accordingly, using the QQT, certain scenarios may save bits that need to be sent by not having the differences sent for certain blocks that have the same quantization parameter. The QQT is then used to determine which blocks have the same quantization parameter.

In one embodiment, if quantization parameters are allowed to vary for a further partitioning, such as quantization parameters vary for a prediction unit (PU), an additional bit may be required to indicate if PUs within a CU share the same quantization parameter or not. If PUs within a current CU use the same quantization parameter, a bit “0” is assigned to the CU, and only one dQP needs to be coded and transmitted for the CU. Otherwise, if PUs within a current CU use different QPs, a bit “1” is assigned to the CU and one dQP is coded and transmitted for each of the PUs within the CU. If quantization parameters are allowed to vary for a further partitioning, such as quantization parameters vary for a transform unit (TU), an additional bit may be required to indicate if TUs within a PU share the same quantization parameter or not.

### Predictive Quantization Parameter Coding

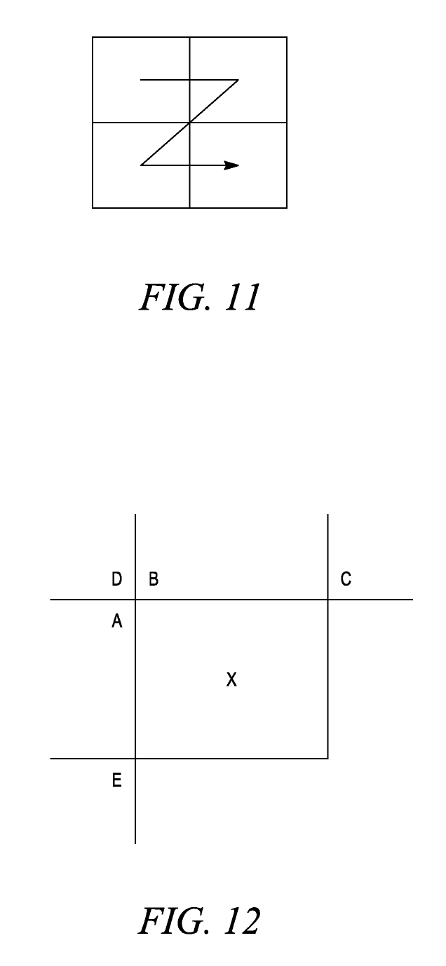

Quantization parameters can be coded predictably. As described in FIG. 1, all LCUs within a picture/slice are coded along a raster scan order, which is from left to right and top to bottom. Within an LCU, coding at each level of the CQT starts from the top-left quadrant, and is followed by the top-right quadrant, bottom-left quadrant and bottom-right quadrant. FIG. 11 shows the scan order within an LCU according to one embodiment.

With the above coding order, given a CU, there can be multiple coded neighbor CUs. FIG. 12 shows the 5 possible coded neighbor CUs for a current CU according to one embodiment. The current CU is denoted as “X” as a CU X. The neighbor CUs are noted as CUs A, B, C, D, E.

In one embodiment, Q_{X} is a quantization parameter for a current CU, CU X, and quantization parameters Q_{A}, Q_{B}, Q_{C}, Q_{D}, and Q_{E} are the quantization parameters for coded neighbor CUs A, B, C, D, and E. If a current CU X has multiple left-neighbor CUs, the left-neighbor quantization parameter QA is a mean of quantization parameters of the left-neighbor CUs. The mean may be the average of the quantization parameters. If a current CU X has multiple above-neighbor CUs, the above-neighbor quantization parameter, Q_{B}, is the mean of the quantization parameters of the above-neighbor CUs.

If the vertical size of a current CU X is smaller than its left-neighbor CU, then quantization parameter Q_{A}=quantization parameter Q_{B}. If the horizontal size of current CU X is smaller than its above-neighbor CU, then quantization parameter Q_{B}=quantization parameter Q_{C}. Additionally, to reduce a memory requirement, a coded LCU may maintain only one quantization parameter for quantization parameter prediction purposes, defined as a mean, media, mode, etc. of quantization parameters of all CUs within the LCU. For example, for current CU X, its left-neighbor CUs A and E are in the left LCU, both quantization parameters Q_{A} and Q_{E} are equal to the quantization parameter of left LCU Q_{left}_{_{—}}_{LCU}.

In one embodiment, for the current CU X, instead of a quantization parameter Q_{X} being sent, a difference between Q_{X} and its prediction Q̅_{X} is coded. That is, the difference quantization parameter, ΔQ_{X}=Q_{X}− Q̅_{X} is coded. The prediction is the quantization parameter for one of the neighboring CUs. Additionally, for a smooth quality variation, ΔQ_{X} may be limited by a specific range and position. For example, ΔQ_{X} can be limited to {−6, −3, −1, 0, 1, 3, 6}, {−3, −2, −1, 0, 1, 2, −3}, or {−2, −1, 0, 1, 2}.

The quantization prediction can be defined as the mean, media, mode, etc. of quantization parameters of all or some available coded neighbor CUs or the quantization parameter one specific neighbor. Availability of the neighbor can be defined as the neighbor with the same coding mode (intra, inter, skip). The following include different examples in which the quantization parameter prediction may be determined. It will be understood other examples may also be appreciated.

### EXAMPLE 1

If 5 neighbor CUs are available,
Q̅_{X}=Pred {Q_{A}, Q_{B}, Q_{C}, Q_{D}, Q_{E}},

### EXAMPLE 2

If CU C is not available,
Q̅_{X}=Pred {Q_{A} , Q_{B}, Q_{D}, Q_{E}}

### EXAMPLE 3

If CU E is not available,
Q̅_{X}=Pred {Q_{A}, Q_{B}, Q_{C}, Q_{D}}

### EXAMPLE 4

If CUs A, D and E are not available,
Q̅_{X}=pred {Q_{B}, Q_{C}}

### EXAMPLE 5

If CUs B, C and D are not available,
Q̅_{X}=Pred {Q_{A}, Q_{E}}

### EXAMPLE 6

In order to avoid store the coding information of above LCU rows, a CU at the top row of a LCU may not use quantization parameters of CUs above. In this case, only CUs A and E may be used, that is,
Q̅_{X}=Pred {Q_{A}, Q_{E}}

### EXAMPLE 7

If only three CUs are allowed, the options can be
Q̅_{X}=Pred {Q_{A}, Q_{B}, Q_{C}}
or
Q̅_{X}=Pred {Q_{A}, Q_{B}, Q_{D}}
or
Q̅_{X}=Pred {Q_{A}, Q_{B}, Q_{E}}

### EXAMPLE 8

If one of neighbor has the same code mode, such as intra, inter, as the current CU, but not other CUs, the quantization parameter of this same code mode neighbor is used as the quantization parameter for the current CU.

### EXAMPLE 9

In cases where QP per either PU or TU is allowed, the above discussions and definition for quantization parameter prediction are extended to either PU or TU.

### Adaptive Quantization Parameter Coding at a Sub-CU Level

Quantization parameters may change at a sub-tree block level. A CU may be various sizes, such as 64×64 and 32×32. Hence, quantization parameter adjustment at a CU or larger level may not be fast enough to respond to changes in content characteristics and buffer conditions. For example, a 64×64 CU may select a 2N×N prediction unit (PU) type where the two PUs represent very different characteristics, such as one is on the edge of an object and the other is in the background. In this example, it may be beneficial to have the freedom to use different quantization parameters for different PUs. The quantization parameter can also be adapted to adjust to a compressed bitrate. This quantization parameter change inside the CU may be provided by allowing quantization parameters to be changed at a sub-CU level, such as at prediction unit (PU) or a transform unit (TU) level. However, the TU/PU may be as small as a 4×4 block and 4×8 block, respectively, and constraints may need to be used for quantization parameter adjustment at the TU/PU level because excessive overhead may result. The overhead may result because of the signaling needed to send the changes for the quantization parameters for the TU/PU blocks. Overhead can also be saved by having decoder 201 implicitly determine the QP parameter.

In one embodiment, two constraints are applied that may keep quantization parameter differences overhead low. The first constraint and the second constraint may be used in combination or separately. For example, the constraints may use a minimum size or dimension of QP adjustment parameter and a fixed quantization parameter per TU/PU size or area. The minimum size of QP adjustment parameter is a global parameter. This constraint limits the smallest area allowed for QP adjustment and it takes effect when TU/PU size or area is smaller than this parameter. For example, the following equation (1) may be used:

QP(m,n)=QP(p,q) if m≦p and n≦q (1)

where QP(m,n) is QP of a TU/PU size, maximum, m and p are width of coding TU/PU and sub-CU area, and n and q are height of coding TU/PU and sub-CU area, respectively. In the case where minimum size or area of QP adjustment parameter is less than TU/PU size or area, that TU/PU can have its own QP.

The second constraint sets all TUs/PUs of the same size or area within a same CU to use the same quantization parameter. Thus, the maximum number of differences that are required to be sent is reduced from a total number of sub-CUs within a CU to a number of TU/PU sizes or areas allowed. When this constraint is used with the first constraint, which requires all TUs/PUs of a size or area smaller than a sub-CU, if any, to employ the same quantization parameter, these constraints provide higher impact when CU size is large and sub-CU size is small. Also, it is possible to use one quantization parameter for multiple TU/PU sizes or areas, such as a quantization parameter QP_a for TU size 32×32 and 16×16, and QP_b for TU size 8×8 and 4×4 or QP_a for PU size 2N×2N, and QP_b for PU size 2N×N, 2N×0.5N, 0.5N×2N, N×2N.

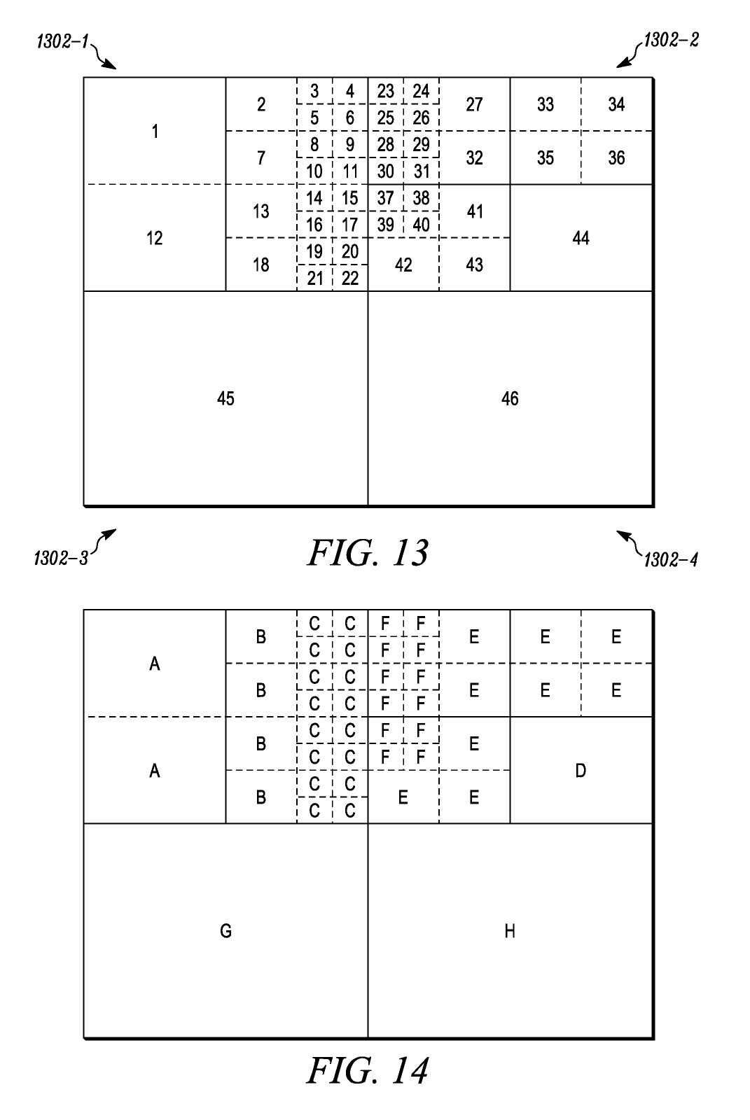

FIG. 13 depicts an example of a TU partitioning within an LCU. A sub-tree size of 64×64 is shown. In this example, four CUs 1302-1, 1302-2, 1302-3, and 1302-4 of 32×32 are chosen in the sub-tree block. A top-left CU 1302-1 uses N×2N PUs. A top-right CU 1302-2 uses N×N PUs and the remaining two CUs 1302-3 and 1302-4 use 2N×2N PUs.

Dashed lines indicate a TU boundary. The number in each of the blocks inside the sub-tree block denotes the processing order of each TU block. For example, a TU #1 is processed first followed by a TU #2, etc. The following describes examples for QP values that may be used.

In the case that a minimum size of QP adjustment parameter is 4×4, FIG. 14 depicts the following QP values are used according to one embodiment. Also, the following summarizes the QP values:

Q(1)=Q(2)=A, TU size 16×16 in the same top left CU

Q(3)=Q(8)=Q(13)=Q(18)=B, TU size 8×8 in the same top left CU

Q(4)=Q(5)=Q(6)=Q(7)=

Q(9)=Q(10)=Q(11)=Q(12)=

Q(14)=Q(15)=Q(16)=Q(17)=

Q(19)=Q(20)=Q(21)=Q(22)=C, TU size 4×4 in the same top left CU

Q(44)=D, TU size 16×16 in the same top right CU

Q(27)=Q(32)=Q(33)=Q(34)=

Q(35)=(Q36)=Q(41)=Q(42)=Q(43)=E, TU size 8x8 in the same top right CU

Q(23)=Q(24)=Q(25)=Q(26)=

Q(28)=Q(29)=Q(30)=Q(31)=

Q(37)=Q(38)=Q(39)=Q(40)=F, TU size 4×4 in the same top right CU

Q(45)=G, TU size 16×16 in the same top right CU

Q(46)=H, TU size 16×16 in the same bottom right CU

where A, B, C, D, E, F, G, H are QP value between 0 and 51

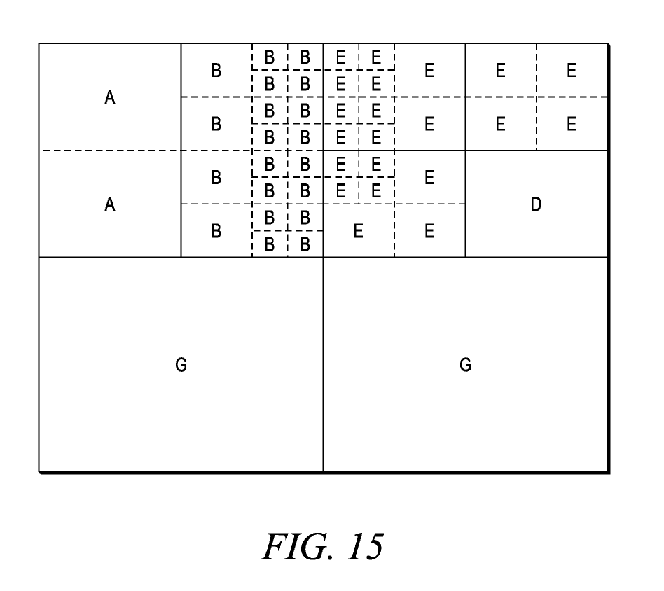

In the case that the minimum size of QP adjustment parameters 8×8, FIG. 15 depicts the QP values that are used according to one embodiment. The following values are reproduced as follows:

Q(3)=Q(8)=Q(13)=Q(18)=B, TU size 8×8 in the same top left CU

Q(4)=Q(5)=Q(6)=Q(7)=

Q(9)=Q(10)=Q(11)=Q(12)=

Q(14)=Q(15)=Q(16)=Q(17)=

Q(19)=Q(20)=Q(21)=Q(22)=B, TU size 4×4 in the same top left CU

Q(44)=D, TU size 16×16 in the same top right CU

Q(27)=Q(32)=Q(33)=Q(34)=

Q(35)=(Q36)=Q(41)=Q(42)=Q(43)=E, TU size 8x8 in the same top right CU

Q(23)=Q(24)=Q(25)=Q(26)=

Q(28)=Q(29)=Q(30)=Q(31)=

Q(37)=Q(38)=Q(39)=Q(40)=E, TU size 4×4 in the same top right CU

Q(45)=G, TU size 16×16 in the same top right CU

Q(46)=H, TU size 16×16 in the same bottom right CU

where A, B, D, E, G, H are QP value between 0 and 51.

### Coding of Quantization Parameter Overhead

Predictive coding may be used to code the quantization parameters. The difference between a current quantization parameter and a predictive quantization parameter, dQP, is coded and sent in the bitstream. In one example, particular embodiments define the QP predictor to be the quantization parameter of the same TU size from the most-recently coded TU. The QP predictor is updated once per TU of a particular TU size. For each CU, the dQP is computed for each TU size larger than the sub-CU. Only the dQP for a TU size that is present in the sub-CU and not equal to 0 is coded. Missing dQP information implies that the difference dQP for that TU size is 0. Referring to FIG. 14, the dQP can be computed as follows:

dQP(16×16)=D−A

dQP(8×8)=E−B

dQP(4×4)=F−C

To reduce overhead further, a relationship between different TU sizes can be defined at a global level, such as a slice or sequence level. This approach only requires that the dQP for each CU to determine the base quantization parameter. A QP predictor may be the base quantization parameter of the most recent re-coded CU of the same type, such as a CU coded in intra or inter mode. The quantization parameter for each TU size within a CU is then determined based on the quantization parameter relationship of that size relative to the base quantization parameter. Another possible solution is to use the average quantization parameter of TU blocks within the most-recently coded CU of the same type. The following equations specify an example of QP coding as described above:

QP(32,32)=QP(base)+a

QP(16,16)=QP(base)+b

QP(8,8)=QP(base)+c

QP(4,4)=QP(base)+d

dQP=QP(base)−QP_predictor (base)

In another example, such as in skipped mode or merge mode, the dQP overhead is not present and is presumed to be 0. That is, the quantization parameter of the same TU size from a CU neighbor indicated by a motion vector predictor index is used.

### Quantization Parameter Predictor Options

Particular embodiments may always maintain the same quantization parameter of all TUs with the same TU size within a CU. That is, the quantization parameter of different TU sizes is independent of each other. Thus, a QP predictor of each TU size can be defined based on its associated CU. The TU size of the most-recently coded CU is used as an example of a QP predictor in that section. However, various other predictors can be used with the proposed adaptive QP algorithm in some predictor determination methods that are described below.

One example to define a CU for the purpose of determining a QP predictor is to rely on adjacent CU neighbors. Different ways may be used to identify the exact CU neighbor, such as by explicitly signaling the exact CU neighbor in the bitstream or implicitly determining the exact CU neighbor based on available information at decoder 201. In one example, an indexing scheme is used as the explicit signaling. One example of implicit signaling is to use a CU that is derived from the predictor motion vector index of the current CU. CUs of the same size from a co-located CU can be used as the reference TU in a current CU. For intra CUs, the CU that contains pixels used for intra prediction can also be used as reference for QP prediction. The TU of the same size as in the reference TU can be used as a reference for QP prediction.

### QP Adaptation

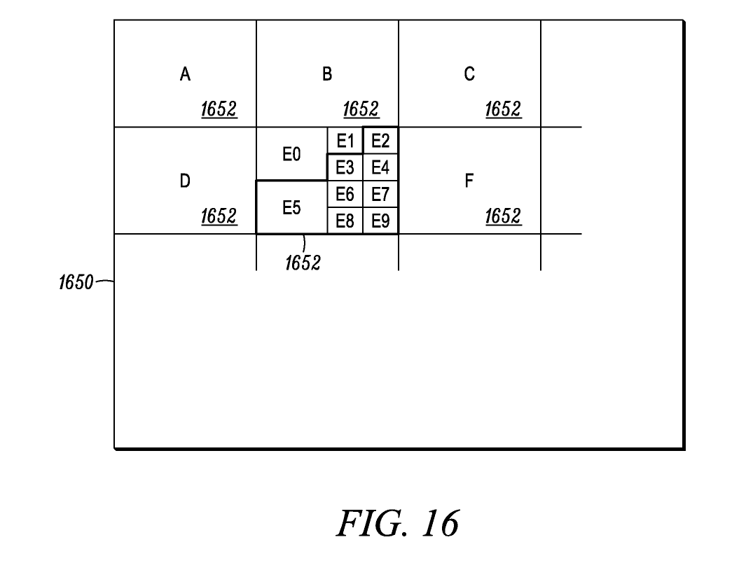

FIG. 16 depicts an example of video content 1650 being coded using QP adaptation according to one embodiment. Video content 1650 may include groupings of units (A-F) 1652. For example, the units may be multiple coding units (CUs), prediction units (PUs), or transform units (TU). The grouping of CUs may be an LCU. As shown, grouping of units E is partitioned into units E0-E9 in a coding order. In one embodiment, the units may be CUs, PUs or TUs.

A current grouping of units may be divided into two regions. Region 1 includes all the units with coded block flags (cbf) equal to zero, along a coding order, but before the first unit with a non-zero cbf within the current grouping of units. Region 2 includes the first unit with a non-zero cbf and the rest of units along the coding order.

In one embodiment, units in a grouping of units 1652 may use a QP predictor for that grouping of units 1652. For example, units in grouping of units E may use the QP predictor for grouping of units E, which may be derived from QP of a coded unit or a grouping of coded units, such as a unit or a grouping of units most recently coded that is the same type as the grouping of units E. This may occur when some units, such as a first number of units in a coding order in grouping of units E, have all the coefficients equal to zero. For example, in FIG. 16, if units E0 and E1 have cbfs equal to zero and unit E2 has a non-zero cbf, units E0 and E1 form region #1 and have the QP set to the QP predictor of the grouping of units E. Region #2 is formed that includes the first coded unit in the grouping, unit E2, and the subsequent units E3-E9 in grouping of units E. Region #2 may have its own QP, which may be coded along with unit E2. As seen, there are two QPs used for the grouping of units E in this example. However, other variations may exist, for examples, the QP predictor of the grouping of units E is used for all the units in the grouping of units E.

In one embodiment, the QP for region #1 may or may not need to be signalled. Two examples are shown as follows.
(1) If the QP for region #1 is not signalled, a derived QP may be used for all the units in region #1 (and in some cases region #2) in the grouping of units. The derived QP may be determined from neighboring units or neighboring groupings of units, such as from neighboring CUs or groupings of CUs.
(2) If the QP for region 1 is signalled, it is only signalled once in the groupings of units. The QP information may be coded along with the first unit in the region.

In one embodiment, a method for determining quantization parameters is provided. The method includes determining one or more first units of video content in a grouping of units. The first units may be CUs, TUs, or PUs. The first units may be in a first region. The method analyzes whether the one or more first units of video content have all of the coefficients for the video content that are zero. The method then determines whether a quantization parameter for one or more second units of video content different from the one or more first units of video content is to be used to derive as the quantization parameter for the one or more first units of video content. The second units may be a neighboring unit or units to the first units in the first region. When the quantization parameter for the one or more second units of video content is to be used, the quantization parameter for the one or more first units of video content is derived from the quantization parameter for the one or more second units of video content. For example, the quantization parameter for the second units is used as the quantization parameter for the first units.

In another embodiment, a method is provided for determining quantization parameters for one or more first units of video content in a grouping of units. The first units may be in a first region. The method determines a quantization parameter for one or more second units of video content different from the one or more first units of video content. For example, the second units include a neighboring unit or neighboring grouping of units to the first units. The method then determines whether the quantization parameter for the one or more second units of video content is to be used to derive a quantization parameter for the one or more first units of video content. The first units of video content have all the coefficients for the video content that are zero. Then, the derived quantization parameter is used as the quantization parameter in decoding the one or more first units of video content. Also, one or more third units of video content in a second region that have a beginning unit in a coding order among units of the one or more third units with coefficients for the video content that are non-zero are determined. The method may determine a second quantization parameter for the one or more third units.

### Method Flows

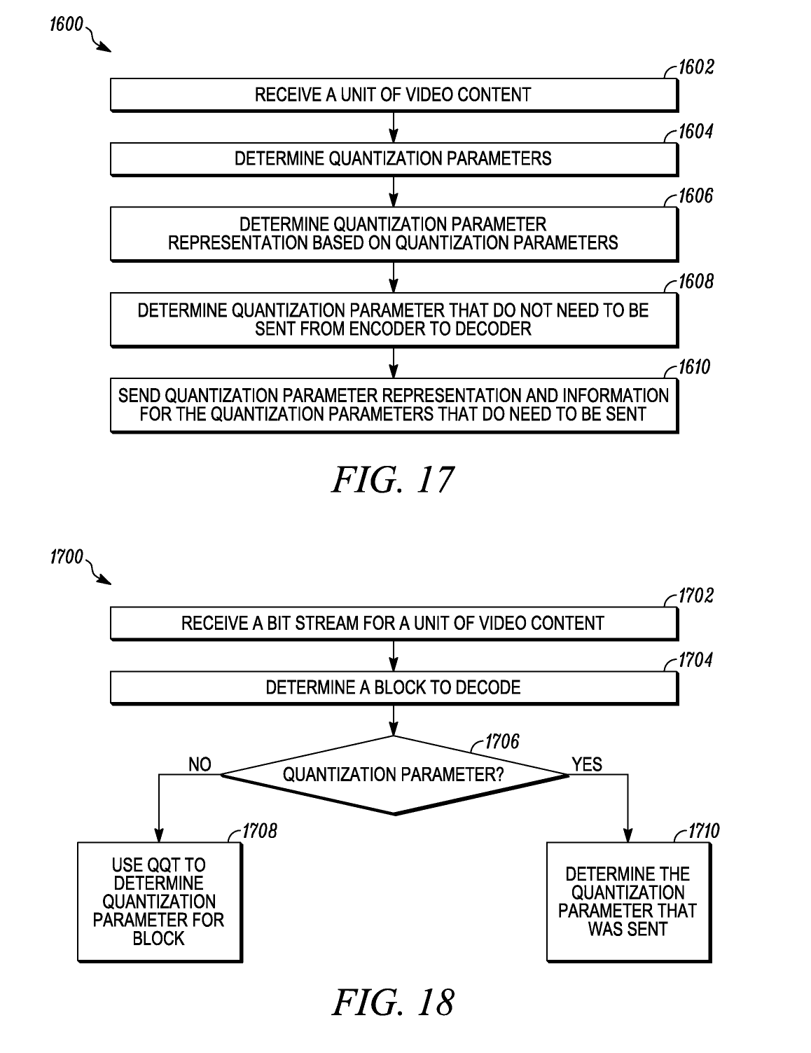

FIG. 17 depicts a simplified flowchart for using a QQT at encoder 200 according to one embodiment. At 1602, a unit of video content is received. The unit may be an LCU being currently encoded. The LCU is partitioned into a plurality of blocks, such as CUs. At 1604, quantization parameters associated with the plurality of blocks are determined For example, quantization parameters for each CU are determined At 1606, a quantization parameter representation based on the quantization parameters and the partitions is determined For example the QQT is determined When a node of the QQT is associated with a block that is split into additional blocks in a corresponding CQT, information is set to indicate whether or not the additional blocks have a same quantization parameter. At 1608, quantization parameters that do not need to be sent from encoder 200 to decoder 201 are determined At 1610, encoder 200 sends the quantization parameter representation and information for the quantization parameters that do need to be sent to decoder 201. Encoder 200 does not send information for the quantization parameters that do not need to be sent.

FIG. 18 depicts a simplified flowchart for using a QQT at decoder 201 according to one embodiment. At 1702, decoder 201 receives a bitstream for a unit of video content. The unit may be an LCU being currently decoded. The LCU is partitioned into a plurality of blocks, such as CUs. At 1704, decoder 201 determines a block to decode. At 1706, decoder 201 determines if information for the quantization parameter for the block was sent. At 1708, if the information was not sent, the QQT is used to determine the quantization parameter from a block that has the same quantization parameter. At 1710, if the quantization parameter was sent, decoder 201 determines that quantization parameter.

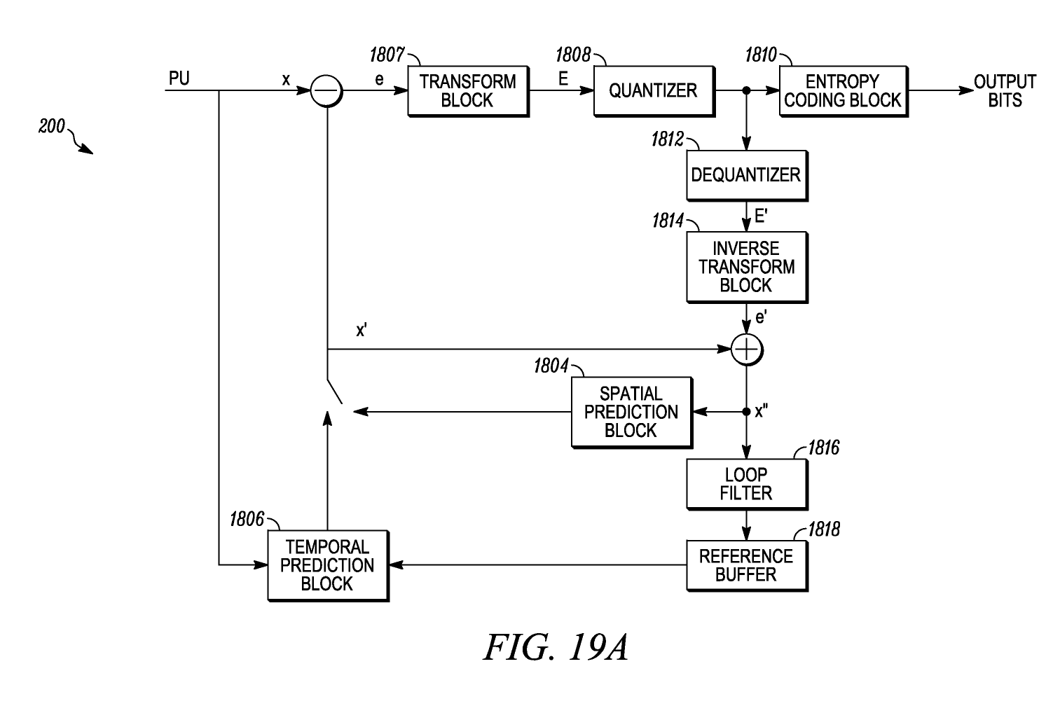

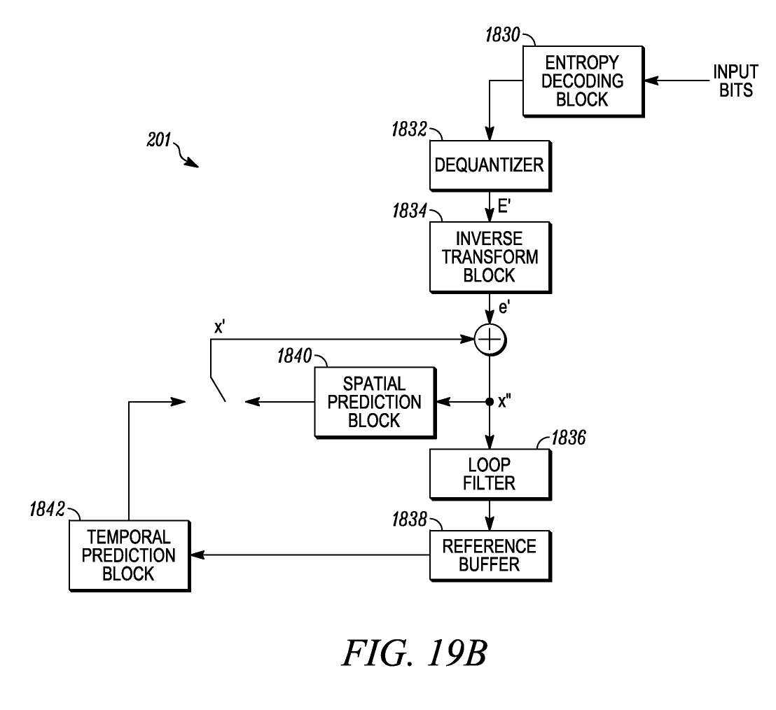

A general operation of an encoder and decoder will now be described. FIG. 19A depicts an example of encoder 200 according to one embodiment. It will be understood that variations on the encoding process described will be appreciated by a person skilled in the art based on the disclosure and teachings herein.

For a current PU, x, a prediction PU, x′, is obtained through either spatial prediction or temporal prediction. The prediction PU is then subtracted from the current PU, resulting in a residual PU, e. A spatial prediction block 1804 may include different spatial prediction directions per PU, such as horizontal, vertical, 45-degree diagonal, 135-degree diagonal, DC (flat averaging), and planar.

A temporal prediction block 1806 performs temporal prediction through a motion estimation operation. The motion estimation operation searches for a best match prediction for the current PU over reference pictures. The best match prediction is described by a motion vector (MV) and associated reference picture (refldx). The motion vector and associated reference picture are included in the coded bitstream.

Transform block 1806 performs a transform operation with the residual PU, e. Transform block 1806 outputs the residual PU in a transform domain, E.

A quantizer 1808 then quantizes the transform coefficients of the residual PU, E. Quantizer 1808 converts the transform coefficients into a finite number of possible values. Entropy coding block 1810 entropy encodes the quantized coefficients, which results in final compression bits to be transmitted. Different entropy coding methods may be used, such as context-adaptive variable length coding (CAVLC) or context-adaptive binary arithmetic coding (CABAC).

Also, in a decoding process within encoder 200, a de-quantizer 1812 de-quantizes the quantized transform coefficients of the residual PU. De-quantizer 1812 then outputs the de-quantized transform coefficients of the residual PU, E′. An inverse transform block 1814 receives the de-quantized transform coefficients, which are then inverse transformed resulting in a reconstructed residual PU, e′. The reconstructed PU, e′, is then added to the corresponding prediction, x′, either spatial or temporal, to form the new reconstructed PU, x″. A loop filter 1816 performs de-blocking on the reconstructed PU, x″, to reduce blocking artifacts. Additionally, loop filter 1816 may perform a sample adaptive offset process after the completion of the de-blocking filter process for the decoded picture, which compensates for a pixel value offset between reconstructed pixels and original pixels. Also, loop filter 1806 may perform adaptive loop filtering over the reconstructed PU, which minimizes coding distortion between the input and output pictures. Additionally, if the reconstructed pictures are reference pictures, the reference pictures are stored in a reference buffer 1818 for future temporal prediction.

FIG. 19B depicts an example of decoder 201 according to one embodiment. It will be understood that variations on the decoding process described will be appreciated by a person skilled in the art based on the disclosure and teachings herein. Decoder 201 receives input bits from encoder 200 for encoded video content.

An entropy decoding block 1830 performs entropy decoding on the input bitstream to generate quantized transform coefficients of a residual PU. A de-quantizer 1832 de-quantizes the quantized transform coefficients of the residual PU. De-quantizer 1832 then outputs the de-quantized transform coefficients of the residual PU, e′. An inverse transform block 1834 receives the de-quantized transform coefficients, which are then inverse transformed resulting in a reconstructed residual PU, e′.

The reconstructed PU, e′, is then added to the corresponding prediction, x′, either spatial or temporal, to form the new reconstructed PU, x″. A loop filter 1836 performs de-blocking on the reconstructed PU, x″, to reduce blocking artifacts. Additionally, loop filter 1836 may perform a sample adaptive offset process after the completion of the de-blocking filter process for the decoded picture, which compensates for a pixel value offset between reconstructed pixels and original pixels. Also, loop filter 1836 may perform adaptive loop filtering over the reconstructed PU, which minimizes coding distortion between the input and output pictures. Additionally, if the reconstructed pictures are reference pictures, the reference pictures are stored in a reference buffer 1838 for future temporal prediction.

The prediction PU, x′, is obtained through either spatial prediction or temporal prediction. A spatial prediction block 1840 may receive decoded spatial prediction directions per PU, such as horizontal, vertical, 45-degree diagonal, 135-degree diagonal, DC (flat averaging), and planar. The spatial prediction directions are used to determine the prediction PU, x′.

A temporal prediction block 1842 performs temporal prediction through a motion estimation operation. A decoded motion vector is used to determine the prediction PU, x′. Interpolation may be used in the motion estimation operation.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method for determining quantization parameters, the method comprising:
determining one or more first units of video content in a grouping of units;
analyzing whether the one or more first units of video content in the grouping of units have coefficients for the video content that are zero;
determining, by a computing device, whether a quantization parameter for one or more second units of video content different from the one or more first units of video content is to be used to derive a quantization parameter for the one or more first units of video content; and
when the quantization parameter for the one or more second units of video content should be used, deriving, by the computing device, the quantization parameter for the one or more first units of video content from the quantization parameter for the one or more second units of video content.

2. The method of claim 1, wherein the one or more first units of video content include a coding unit, prediction unit, or a transform unit.

3. The method of claim 1, wherein the quantization parameter changes at a coding unit, prediction unit, or a transform unit level within the grouping of units.

4. The method of claim 1, further comprising not sending the derived quantization parameter for a portion of the one or more first units of video content within the region.

5. The method of claim 1, further comprising signaling the derived quantization parameter from an encoder to a decoder.

6. The method of claim 1, further comprising:
determining one or more third units of video content that have a beginning unit in a coding order among units of the one or more third units with coefficients for the video content that are non-zero; and
determining a second quantization parameter for the one or more third units.

7. The method of claim 6, wherein:
the one or more first units are in a first region,
the one or more third units are in a second region, wherein the first region and the second region are within the grouping of units,
the one or more first units of video content in the first region have the derived quantization parameter, and
the one or more third units of video content in the second region have the second quantization parameter.

8. The method of claim 6, wherein:
the one or more first units are in a first region,
the one or more third units are in a second region, wherein the first region and the second region are within the grouping of units, the grouping of units being in the coding order,
the one or more first units of video content in the first region all have non-zero coefficients, wherein the one or more first units of video content are in the coding order before the second region.

9. A method for determining quantization parameters for one or more first units of video content in a grouping of units, the method comprising:
determining, by a computing device, a quantization parameter for one or more second units of video content different from the one or more first units of video content;
determining, by the computing device, the received quantization parameter is to be used to derive a quantization parameter for the one or more first units of video content, wherein the one or more first units of video content are in the grouping of units and have coefficients for the video content that are zero; and
using, by the computing device, the derived quantization parameter in decoding the one or more first units of video content.

10. The method of claim 9, further comprising:
determining one or more third units of video content that have a beginning unit in a coding order among units of the one or more third units with coefficients for the video content that are non-zero; and
determining a second quantization parameter for the one or more third units.

11. The method of claim 10, wherein:
the one or more first units are in a first region,
the one or more third units are in a second region, wherein the first region and the second region are within the grouping of units,
the one or more first units of video content in the first region have the quantization parameter for the one or more second units, and
the one or more third units of video content in the second region have the second quantization parameter.

12. The method of claim 10, wherein:
the one or more first units are in a first region,
the one or more third units are in a second region, wherein the first region and the second region are within the grouping of units, the grouping of units being in the coding order,
the one or more first units of video content in the first region all have non-zero coefficients, wherein the one or more first units of video content are in the coding order before the second region.

13. A method for encoding video content, the method comprising:
receiving a unit of video content, wherein the unit is partitioned into a grouping of blocks;
determining quantization parameters associated with the grouping of blocks;
determining, by a computing device, a quantization parameter representation based on the quantization parameters and the grouping of blocks, wherein when a node of the quantization parameter representation is associated with a block that is split into additional blocks, node information is set to indicate whether or not the additional blocks have a same quantization parameter; and
sending quantization information for the quantization parameters for the grouping of blocks based on the quantization parameter representation.

14. The method of claim 13, wherein:
the grouping of blocks are coding units,
a coding unit representation is determined based on the partitioning of the grouping of blocks, wherein a node of the coding unit representation includes coding unit information when a coding unit is split into additional coding units, and
for at least a portion of nodes of the coding unit representation that include coding unit information, the quantization parameter representation includes node information indicating whether the additional coding units include the same quantization parameter.

15. The method of claim 13, further comprising:
determining which additional blocks have the same quantization parameter, and
not sending quantization information for the same quantization parameter for at least a portion of the additional blocks.

16. The method of claim 15, wherein not sending comprises:
determining a difference for a quantization parameter for a first block and another block;
sending the difference for the quantization parameter to a decoder for the first block; and
not sending the same difference for the quantization parameter for the other blocks in the additional blocks.

17. The method of claim 13, wherein:
the node information that is set comprises a bit to indicate whether a group of additional blocks in which a block is split include the same quantization parameter, and
no node information is set if the node is not associated with a block that is split into any additional blocks.

18. The method of claim 13, wherein the quantization parameter of the current block is determined based on quantization parameters of at least a portion of neighbor blocks for the current block.

19. The method of claim 13, wherein:
quantization parameters vary at a level of a sub-unit within the unit of video,
a minimum size of QP adjustment parameter defines a minimum size allowed for QP variance, and
when sub-unit size or area is smaller than the minimum size, the quantization parameters for transform units are the same within areas that are smaller or equal than the minimum size.

20. The method of claim 13, wherein the sub-unit comprises a transform unit or a prediction unit.

21. The method of claim 13, wherein:
quantization parameters vary at a level of transform units within the unit of video, and
the quantization parameters for transform units are the same for transform units of a same size within the unit of video content.

22. A method for decoding video content, the method comprising:
receiving a bitstream for a unit of video content, wherein the unit is partitioned into a grouping of blocks;
determining, by a computing device, a quantization parameter representation based on a plurality of quantization parameters and the grouping of blocks, wherein when a node of the quantization parameter representation is associated with a block that is split into additional blocks, node information is set to indicate whether or not the additional blocks have a same quantization parameter; and
determining, by the computing device, a quantization parameter associated with a current block being decoded using the quantization parameter representation; and
using the quantization parameter in a quantization step.

23. The method of claim 22, wherein determining the quantization parameter comprises:
determining if a node in the quantization parameter representation indicates the quantization parameter for the current block is a same quantization parameter as another block;
if the quantization parameter for the current block is the same quantization parameter as another block, using the quantization parameter for the another block; and
if the quantization parameter for the current block is not the same quantization parameter as another block, determining the quantization parameter for the current block, wherein information for the quantization parameter for the current block is sent in the bitstream.

24. The method of claim 22, wherein information for quantization parameters for at least a portion of the grouping of blocks is not received at a decoder.

25. The method of claim 22, wherein determining the quantization parameter representation comprises receiving the quantization parameter representation from an encoder or implicitly deriving the quantization parameter representation at a decoder.
